(19) United States
(12) Patent Application Publication
(10) Pub. No.: US 2016/0061275 A1
(43) Pub. Date: Mar. 3, 2016

(54) TRANSMISSION SYSTEM HAVING A DOUBLE WET CLUTCH MECHANISM

(71) Applicant: VALEO EMBRAYAGES, Amiens Cedex 2 (FR)

(72) Inventors: Rabah ARHAB, Saint-Brice-Sous-Foret (FR); Herve RIBOT, Peronne (FR); Laurent CAUMARTIN, Beauquesne (FR)

(21) Appl. No.: 14/841,784

(22) Filed: Sep. 1, 2015

(30) Foreign Application Priority Data
Sep. 3, 2014 (FR) 1458238

(51) Int. Cl. F16D 25/0638; F16D 25/10

(52) U.S. Cl. CPC F16D 25/0638; F16D 25/10

(57) ABSTRACT

A transmission system (10), especially for a motor vehicle, having around an axis (O) at least a double wet clutch mechanism (20) having at least a first clutch (E1) and a second clutch (E2) respectively of the multiple-disc type, wherein the mechanism (20) has connecting means (85) arranged axially between the pistons (30, 90) of the clutches (E1, E2) which, for direct transmission of input power, connect together, with zero axial clearance, at least a drive web (18), an internal disc carrier (80) of the first clutch (E1), an internal disc carrier (130) of the second clutch (E2), and reaction means (60) interposed axially between the internal disc carriers (80, 130).

### CROSS-REFERENCE TO RELATED APPLICATIONS AND CLAIM TO PRIORITY

This application claims is related to patent Application No. 1458238 filed Sep. 3, 2014 in France, the disclosure of which is incorporated herein by reference and to which priority is claimed.

### FIELD OF THE INVENTION

The present invention relates to a transmission system having a double wet clutch mechanism.

### BACKGROUND OF THE INVENTION

The present invention relates more particularly to a transmission system, especially for a motor vehicle, having around an axis at least
an input shell that is rotationally connected to a driving shaft and to a drive web in order to rotationally connect said input shell to a double wet clutch mechanism that is controlled to selectively couple said driving shaft to a first driven shaft and to a second driven shaft,
   said double wet clutch mechanism having at least a first clutch and a second clutch respectively of the multiple-disc type, each of said first and second clutches having at least one axially movable piston that is controlled as to displacement by means of a control chamber with which is associated a compensating chamber delimited at least by a compensating piston, said piston causing axial clamping, in an engaged position, of a multiple-disc assemblage against reaction means, said multiple-disc assemblage having at least friction discs rotationally connected to an external disc carrier and flanges that are rotationally connected via at least one internal disc carrier to one of said first and second driven shafts.

Transmission systems of this kind having a double clutch mechanism are known from the existing art.

A distinction is made in particular between two double clutch mechanism designs: on the one hand so-called double “dry” clutch mechanisms, and on the other hand so-called double “wet” clutch mechanisms.

The present invention relates more particularly to a double wet clutch.

In the case of a double wet clutch mechanism, the clutches are generally of the multiple-disc type, and the friction linings of the discs are kept constantly wet by oil.

A double clutch mechanism has a first clutch, arranged for example on the gearbox side, that serves both for starting and for engagement of the odd-numbered ratios, and a second clutch, arranged for example on the engine side, that handles the even-numbered ratios and the reverse gear.

The first clutch and the second clutch alternatively transmit input power (torque and speed) from the driving shaft, which is rotationally connected to the engine, to one of the two driven shafts that are connected to the gearbox and are generally coaxial.

For increased safety, the first clutch and the second clutch of the mechanism are respectively disengaged when at rest, i.e. are “normally open,” and are actively closed by hydraulic actuating means of a control device that is associated with the double clutch mechanism.

The increasing attention being paid to double clutch mechanisms has to do in particular with the comfort and performance obtained, as well as continuous acceleration during gear changes with no interruption in torque.

Transmission systems having such a double clutch mechanism also provide a benefit in terms of consumption and CO₂ emission as compared especially with a traditionally automatic gearbox.

Known transmission systems having a double wet clutch mechanism are nevertheless not entirely satisfactory, especially for certain applications.

In certain applications, especially but not exclusively for industrial vehicles such as trucks and utility vehicles, what is desired is reliable transmission of large torques with a transmission system that is still radially compact, for example in order to allow installation between the engine and gearbox of the vehicle.

The engine torque to be transmitted by transmission systems has been steadily growing for several years, reaching values on the order of 4000 Nm. Known architectures for transmission systems having a double wet clutch mechanism do not allow these torque values to be transmitted, and do not offer satisfactory reliability.

### SUMMARY OF THE INVENTION

The object of the present invention is in particular to propose a transmission system, having a double wet clutch mechanism, capable of overcoming at least some of certain disadvantages of the existing art.

To this end, the invention proposes a transmission system of the kind recited previously, wherein said double wet clutch mechanism has connecting means arranged axially between the pistons of the first clutch and of the second clutch which, for direct transmission of input power, connect together with zero axial clearance at least said drive web, the internal disc carrier of the first clutch, the internal disc carrier of the second clutch, and said reaction means interposed axially between said internal disc carriers.

In other words, the invention proposes a transmission system, especially for a motor vehicle, having around an axis at least
an input shell that is rotationally connected to a driving shaft and to a drive web in order to rotationally connect said input shell to a double wet clutch mechanism that is controlled to selectively couple said driving shaft to a first driven shaft and to a second driven shaft,
   said double wet clutch mechanism having at least a first clutch and a second clutch respectively of the multiple-disc type, each of said first and second clutches having at least one axially movable piston that is controlled as to displacement by means of a control chamber with which is associated a compensating chamber delimited at least by a compensating piston, said piston causing axial clamping, in an engaged position, of a multiple-disc assemblage against reaction means, said multiple-disc assemblage having at least friction discs rotationally connected to an external disc carrier and flanges that are rotationally connected via at least one internal disc carrier to one of said first and second driven shafts,
   wherein the drive web, the internal disc carrier of the first clutch, the internal disc carrier of the second clutch, and said reaction means interposed axially between said internal disc carriers are separate parts; and said double wet clutch mechanism has connecting means arranged axially between the pistons of the first clutch and of the second clutch which, for direct transmission of input power, connect at least the separate parts together with zero axial clearance.

Thanks to the connecting means, input power is transmitted directly to the first clutch and to the second clutch of the double wet clutch mechanism.

Advantageously, direct transmission of power within the two clutches by way of common connecting means can allow the same reliability to be ensured for both clutches. Establishment of a common connecting means for the two clutches allows the engine torque transmission capacity to be increased.

According to other characteristics of the invention:
said connecting means also connect, with zero axial clearance, the compensating piston of the first clutch;
said connecting means also connect, with zero axial clearance, the compensating piston of the second clutch;
said connecting means are implemented by riveting;
said connecting means have at least a series of first rivets associated with the first clutch and a series of second rivets associated with the second clutch;
said first rivets connect, with zero axial clearance, at least said drive web, the internal disc carrier of the first clutch, and said reaction means;
said first rivets also connect, with zero axial clearance, the compensating piston of the first clutch;
said second rivets connect, with zero axial clearance, at least the internal disc carrier of the second clutch and said reaction means;
said second rivets also connect, with zero axial clearance, the compensating piston of the second clutch;
oil passages are configured to allow oil circulation radially outward at the level of the connecting means;
the compensating piston of the first clutch and the compensating piston of the second clutch have indentations that delimit, between two circumferentially consecutive indentations, said radial oil passages;
said radial oil passages are constituted by windows obtained by cutting out the internal disc carrier between circumferentially consecutive fastening tabs;
the drive web has openings for axial passage of an actuating portion of the piston of the first clutch;
the drive web constitutes the compensating piston of the first clutch;
the first clutch and the second clutch of said double wet clutch mechanism are axially juxtaposed, the first clutch and the second clutch being arranged axially on either side of said reaction means;
the piston of the first clutch and the piston of the second clutch of said double wet clutch mechanism travel axially in opposite directions in order to cause clamping of said associated friction discs in an engaged position;
said connecting means are implemented by welding, in particular by transmission laser welding;
the first clutch and the second clutch have resilient return means in order to automatically return the piston to the disengaged position;
the resilient piston return means are axially interposed between at least a portion of the friction discs and flanges of the clutch.
the piston return means of a clutch are constituted by at least one spring that is arranged radially between the axis 0 and the internal disc carrier in order to automatically return the piston toward the disengaged position.
said connecting means are installed radially between the axis O and the multiple-disc assemblage.

Advantageously, radial installation of the connecting means between the axis O and the multiple-disc assemblage imparts radial compactness to the transmission system.

### BRIEF DESCRIPTION OF THE DRAWINGS

Other characteristics and advantages of the invention will emerge upon reading the detailed description below, which will be understood upon reference to the attached drawings in which:

FIG. 1 is an axial half section view that depicts a transmission system having a double wet clutch mechanism and that illustrates a first embodiment of the invention in which the connecting means are implemented by riveting, by means of rivets that connect all the parts with zero axial clearance;

FIG. 2 is an axial half section view, shifted angularly with respect to that of FIG. 1, that depicts the transmission according to the first embodiment and that illustrates in particular one of the radial oil circulation passages existing between two consecutive indentations associated with the rivets, on the one hand on the drive web that constitutes the compensating piston of the first clutch, and on the other hand on the compensating piston of the second clutch;

FIG. 3 is a perspective view that depicts respectively the internal disc carrier of the first clutch and the compensating piston of the first clutch constituted by the drive web, and that illustrates the radial oil circulation passages existing between the radial face of said disc carrier and the radial face of the compensating piston in the non-recessed regions of the face;

FIG. 4 is a perspective view that depicts respectively the internal disc carrier of the second clutch and the compensating piston of the second clutch and that, like FIG. 3, illustrates the radial oil circulation passages existing between the radial face of said disc carrier and the radial face of the compensating piston, constituted by the web, in the non-recessed regions of its face;

FIGS. 5 and 6 are axial half section views that respectively depict, analogously to FIG. 1, a transmission system having a double wet clutch mechanism according to a second embodiment, and that illustrate connecting means implemented by riveting, having at least a series of first rivets for connecting parts of the first clutch with zero axial clearance and another series of second rivets for connecting parts of the second clutch of said mechanism with zero axial clearance;

FIG. 7 is an axial half section view that depicts the transmission system according to the second embodiment and that, shifted angularly with respect to that of FIGS. 5 and 6, illustrates for each clutch one of the radial oil circulation passages, respectively between the internal disc carrier and the compensating piston, constituted by the inner radial portion of the drive web, for the first clutch, and between the internal disc carrier and the compensating piston for the second clutch;

FIG. 8 is a perspective view that respectively depicts, analogously to FIG. 4, the internal disc carrier of the first clutch and the compensating piston of the first clutch, constituted by the inner radial portion of the drive web, and that illustrates the radial oil circulation passages existing between the face of said disc carrier and the radial face of the compensating piston, constituted by the web, in the non-recessed regions of said face;

FIG. 9 is a perspective view that depicts respectively the internal disc carrier of the second clutch and the compensating piston of the second clutch, and that, like FIG. 8, illustrates the radial oil circulation passages existing between the face of the disc carrier and the radial face of the compensating piston in the non-recessed regions of said face;

FIGS. 10 to 12 are axial half section views that, analogously to FIGS. 5 to 7, depict a transmission system according to a third embodiment and that illustrate, more particularly in FIG. 12, radial oil passages formed by cutting out the internal disc carrier of each clutch of the mechanism;

FIG. 13 is a perspective view that, analogously to FIG. 8, depicts the internal disc carrier of the first clutch having a cutout between two circumferentially consecutive fastening tabs in order to form, after connection to the compensating piston of the first clutch constituted by the inner radial portion of the drive web, windows that constitute said oil circulation passages; and that illustrates an example of the shape of said cutouts implemented in the internal disc carrier;

FIG. 14 is a perspective view that, analogously to FIG. 9, depicts the internal disc carrier of the second clutch and the compensating piston of the second clutch and that illustrates, for the second clutch, said cutouts in the internal disc carrier in order to form, after connection to the compensating piston by riveting, windows that constitute said radial oil circulation passages between the disc carrier and the compensating piston.

### DETAILED DESCRIPTION OF THE PREFERRED EMBODIMENT(S)

In the description below and in the claims, the terms “front” or “rear” will be used, in non-limiting fashion and in order to facilitate understanding, in accordance with the direction with respect to an axial orientation determined by the principal axis of rotation O of the transmission system, as well as the terms “internal/inner” or “external/outer” with respect to the axis O and in accordance with a radial orientation orthogonal to said axial orientation.

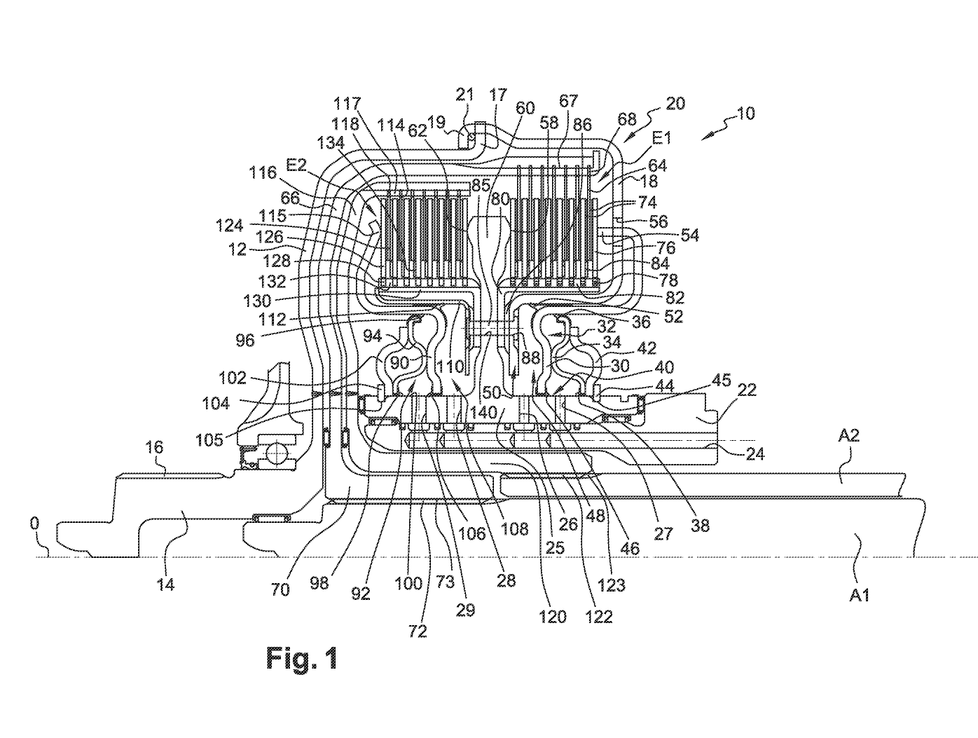

FIGS. 1 to 4 depict a first embodiment of a transmission system 10, in particular for a motor vehicle, having a principal rotation axis O.

Transmission system 10 has, around axis O, at least one input element that is rotationally connected to a driving shaft (not depicted).

The input element of system 10 preferably has at least one input shell 12 that is rotationally connected to an input hub 14.

Input shell 12, having an overall L-shape, has a radially oriented portion and an axially oriented portion.

Hub 14 has a radially oriented portion and an axially oriented portion, hub 14 being arranged radially internally with respect to shell 12.

The axially oriented portion of hub 14 extends inside the radial portion, axially rearward, in a direction corresponding to that of the engine.

Hub 14 has splines 16, configured in an outer cylindrical surface of the axial portion, for rotational connection of the input element, constituted at least by shell 12 and hub 14, to the driving shaft.

The internal end of the radial portion of shell 12 and the external end of the radial portion of input hub 14 are in one piece, preferably fastened together by welding.

As a variant, the internal end of the radial portion of input shell 12 and the external end of the radial portion of input hub 14 are fastened together by riveting.

Input hub 14 is, for example, rotationally connected by means of splines 16 to the output of a damping device or damper (such as a dual mass flywheel), the input of which is connected, in particular by means of an engine flywheel, to the driving shaft constituted by a crankshaft that is caused to rotate by an engine that is part of the motor vehicle.

Input shell 12 is caused to rotate by the engine by means of input hub 14.

Input shell 12 is rotationally connected to a drive web 18, said drive web 18 rotationally connecting said input shell 12 to a double wet clutch mechanism 20.

Input shell 12 and drive web 18 are rotationally connected by positive interaction.

Input shell 12 has, at its axially oriented radial outer end, tabs 17 that extend radially outward and interpenetrate with tabs 19 that drive web 18 comprises at its axially oriented radial outer end.

Tabs 19 of drive web 18 extend radially inward and are offset angularly with respect to tabs 17 so as to become axially inserted, circumferentially, between two consecutive tabs 17 of input shell 12.

An annular circlip 21 is received axially between tabs 17 of input shell 12 and tabs 19 of drive web 18.

Double wet clutch mechanism 20 is controlled to selectively couple said driving shaft to a first driven shaft A1 and to a second driven shaft A2.

First driven shaft A1 and second driven shaft A2 are preferably coaxial.

Double wet clutch mechanism 20 has at least a first clutch E1 and a second clutch E2 that are respectively of the multiple-disc type.

First driven shaft A1 is caused to rotate when said first clutch E1 is closed, and second driven shaft A2 is caused to rotate when said second clutch E2 is closed, said first and second driven shafts A1, A2 being respectively connected to a gearbox that is part of the motor vehicle.

In double wet clutch mechanism 20, first clutch E1 serves e.g. both for starting and for engaging the odd-numbered ratios, and second clutch E2 then handles the even-numbered ratios and the reverse gear; as a variant, the ratios handled by said first clutch E1 and second clutch E2 are interchanged.

First clutch E1 is arranged, for example, axially at the front on the gearbox side of input web 14, and second clutch E2 is arranged, for example, axially at the rear on the engine side of input web 14.

First clutch E1 and second clutch E2 alternatively transmit input power (torque and speed) from the driving shaft, which is received by input shell 12 of system 10, to one of the two driven shafts A1, A2 depending on the open or closed state of each of clutches E1 and E2.

Preferably first clutch E1 and second clutch E2 are in the open state, also called “normally open,” and are actuated selectively during operation by a control device (not depicted) in order to transition from the open state to the closed state.

Double wet clutch mechanism 20 is controlled hydraulically by means of a pressurized fluid, generally oil.

In order to selectively control the change of state of first clutch E1 and of second clutch E2 of mechanism 20 of transmission system 10, the control device has at least one control shaft 22 having oil supply channels 24, for example four thereof as depicted in FIG. 1.

Mechanism 20 has at least one hub 25 having four radial orifices 26, 27, 28, 29 that are each connected to one of oil supply channels 24; the two orifices 26 and 27 are associated with control of first clutch E1 located axially at the front, and the other two orifices 28 and 29 are associated with control of second clutch E2 located axially at the rear.

First clutch E1 of the multiple-disc type has a piston 30 that is movable axially, here from front to rear, between a disengaged position and an engaged position which correspond respectively to the open and closed states of first clutch E1.

Piston 30 is controlled as to displacement by means of a control chamber 32 delimited axially by a front face of a inner radial portion of piston 30 and by the rear radial face of a closure part 34.

Closure part 34 carries, at its outer radial end, sealing means 36 that interact with an inner face of an axial portion of piston 30 and, at its inner radial end, sealing means 38 that interact with an outer axial surface 40 of hub 25.

Closure part 34 is preferably associated with an abutment part 42 that is axially immobilized by a stop ring 44 mounted in a groove 45 of hub 25.

Advantageously, the axial forces associated with pressurization of control chamber 32 are absorbed by abutment part 42 and not by closure part 34 that carries sealing means 36 and 38.

Piston 30 has at its inner radial end sealing means 46 that interact with outer axial surface 40 of hub 25 when piston 30 is displaced axially between the disengaged and engaged positions by the pressurization of control chamber 32.

Closure part 34 of control chamber 32 of piston 30 has, between its two radial ends carrying sealing means 36 and 38, a convex segment that interacts with the front radial face of the axially opposite piston 30.

The volume of control chamber 32 has an external portion and an internal portion, located radially on either side of said convex segment of closure part 34.

Control chamber 32 is supplied with oil via orifice 27 that passes radially through hub 25, orifice 27 effecting communication between said control chamber 32 and one of oil supply channels 24.

Control chamber 32 of piston 30 of first clutch E1 is associated with a compensating chamber 48 delimited at least by a compensating piston 50.

Advantageously, drive web 18 constitutes compensating piston 50 of first clutch E1.

Drive web 18 thus has a dual function: on the one hand transmitting input power, and on the other hand as a compensating piston in the operation of first clutch E1.

More precisely, the function as compensating piston 50 of first clutch E1 is provided principally by the inner radial portion of said web 18.

As a variant, compensating piston 50 and drive web 18 are implemented in the form of two separate parts.

Compensating chamber 48 of first clutch E1 is delimited axially by the front radial face of compensating piston 50 constituted by the inner radial portion of drive web 18 and by the rear radial face of piston 30.

Compensating chamber 48 is supplied with oil via orifice 26 that hub 25 comprises.

Sealing of compensating chamber 48 is provided radially externally by sealing means 52 that are carried by piston 30 and that interact with the inner face of an axial portion of compensating piston 50 constituted by drive web 18.

Piston 30 of first clutch E1 extends radially and is disposed axially between control chamber 32 located axially at the front, and compensating chamber 48 located axially at the rear.

Piston 30 of first clutch E1 has, at its external radial end, an actuating portion constituted by fingers 54 that extend axially toward the rear in order to act on a multiple-disc assemblage of first clutch E1.

Advantageously, drive web 18 has openings 56 for axial passage of said fingers 54 that constitute the actuating portion of piston 30 of clutch E1.

Piston 30 is controlled to cause axial clamping, in the engaged position, of said multiple-disc assemblage of first clutch E1 against a reaction face 58 of reaction means 60.

Reaction means 60 are rotationally connected to hub 25. Reaction means 60 and hub 25 are preferably implemented as one part, as a variant as two parts fastened together by any means, e.g. by riveting or welding.

Reaction means 60 constitute a disc that extends radially outward from hub 25 and, advantageously in a manner common to first clutch E1 and second clutch E2, extend axially between said clutches E1 and E2.

Reaction means 60 have a reaction face 62 for second clutch E2 which, axially oppositely to front reaction face 58 of first clutch E1, is oriented to the rear.

First clutch E1 and second clutch E2 of said double wet clutch mechanism 20 are actuated axially in opposite directions, i.e. axially from front to rear against face 58 for piston 30 of first clutch E1, and axially from rear to front against face 62 for that of second clutch E2.

In transmission system 10 depicted in FIGS. 1 to 4, first clutch E1 and second clutch E2 of said double wet clutch mechanism 20 are axially juxtaposed, first clutch E1 and second clutch E2 being arranged axially on either side of said reaction means 60.

The multiple-disc assemblage of first clutch E1 has at least friction discs 64 that are rotationally connected to first driven shaft A1 by an external disc carrier 66. External disc carrier 66 constitutes the output element of first clutch E1.

External disc carrier 66 has at the external radial periphery an axial portion that is equipped with a tooth set 67 intended to interact with a complementary tooth set 68 that each friction disc 64 comprises at its external radial periphery.

External disc carrier 66 has three radial holes, circumferentially distributed in said axial portion equipped with tooth set 67, and intended for passage of the oil introduced into the multiple-disc assemblage of first clutch E1.

External disc carrier 66 is rotationally connected by meshing to friction discs 64, and by a splined connection to said first driven shaft A1.

External disc carrier 66 has an output hub 70 that extends axially and has, radially internally, axial splines 72 that mesh with complementary splines 73 of first driven shaft A1.

External disc carrier 66 has an overall L-shape, the internal radial end of which, opposite tooth set 67, is in one piece with output hub 70.

External disc carrier 66 and output hub 70 are preferably fastened together by welding, as a variant by riveting.

Friction discs 64 each have a friction lining 74 on their respective front and rear axially opposite radial faces.

The multiple-disc assemblage of first clutch E1 has flanges 76 that are equipped at their inner radial periphery with a tooth set 78 in order to rotationally connect them to an internal disc carrier 80.

Internal disc carrier 80 has at its outer radial end an axial portion having an outer tooth set 82 that, in complementary fashion, meshes with inner tooth set 78 of each of flanges 76 in order to rotationally connect them with zero clearance.

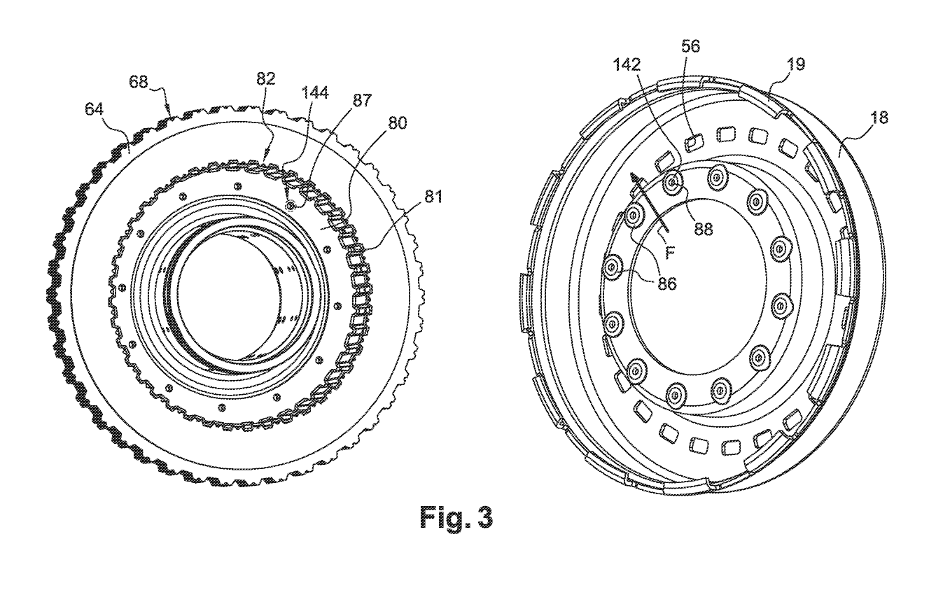

As illustrated in FIG. 3, internal disc carrier 80 has radial holes 81, distributed circumferentially in said axial portion equipped with tooth set 82, and intended for passage of the oil introduced into the multiple-disc assemblage of first clutch E1.

Friction discs 64 are, in individual fashion, axially interposed between two successive flanges 76. Each of the friction linings 74 of one of friction discs 64 interacts, in an engaged position, with one of the radial faces of flanges 76 arranged axially on either side (at the front and at the rear) of said friction disk 64.

The multiple-disc assemblage of first clutch E1 has, axially, a flange 76 at each of its ends, respectively a front flange 76 whose front radial face is intended to interact, in an engaged position, with fingers 54 forming the actuating portion of piston 30; and a rear flange 76 whose rear radial face is intended to interact with front face 58 of reaction means 60.

First clutch E1 has resilient return means 84 for automatically returning piston 30 into a disengaged position corresponding to an open state of the clutch.

Resilient return means 84 for piston 30 are preferably constituted by resilient washers, such as spring washers of the “Onduflex™” type.

Resilient washers 84 are interposed axially between flanges 76 and are arranged radially inside friction discs 64, below friction linings 74. Each resilient washer 84 abuts axially against the rear radial face of a flange 76 and against the front radial face of another axially adjacent flange 76.

Resilient return means 84 impinge axially on flanges 76 and, by so doing, facilitate the release of friction discs 64 and the return of piston 30 to the disengaged position.

As a variant that is not depicted, the piston return means 84 of a clutch are constituted by at least one spring that is arranged, for example, radially between axis O and internal disc carrier 80 in order to automatically return piston 30 toward the disengaged position.

For direct transmission of input power, double wet clutch mechanism 20 has connecting means that, for first clutch E1, connect at least drive web 18, internal disc carrier 80, and reaction means 60 with zero axial clearance.

When drive web 18 and compensating piston 50 are, as a variant, implemented as two separate parts, the connecting means then likewise connect said compensating piston 50 to drive web 18, internal disc carrier 80, and reaction means 60 with zero axial clearance.

When compensating piston 50 of first clutch E1 is constituted by drive web 18, mechanism 20 has one less part; the advantages are, in particular, less cost and greater simplicity and axial compactness.

In this first embodiment, the connecting means are implemented by riveting.

As a variant that is not depicted, the connecting means are implemented by welding, in particular by transmission laser welding.

Drive web 18 has indentations 86 that are circumferentially distributed and project axially rearward with respect to the rear radial face of drive web 18 that constitutes compensating piston 50.

As depicted in FIG. 3, indentations 86 each surround a hole 88 intended for axial passage of one of rivets 85 that constitute said connecting means.

In this first embodiment, rivets 85 that constitute the connecting means are common to first clutch E1 and to second clutch E2, which will now be described.

Second clutch E2 of double wet clutch mechanism 20 of transmission system 10 is similar in design to first clutch E1, second clutch E2 being of the multiple-disc type.

The detailed description provided above of first clutch E1 may advantageously be consulted as necessary for a description of second clutch E2.

Second clutch E2 has a piston 90 that is axially movable (here from rear to front) between a disengaged position and an engaged position corresponding respectively to the open and closed states of second clutch E2 of mechanism 20.

Piston 30 of first clutch E1 and piston 90 of second clutch E2 of said double wet clutch mechanism 20 travel axially in opposite directions in order to transition, for example, from the disengaged position to the engaged position.

Piston 90 of second clutch E2 is controlled as to displacement by means of a control chamber 92 delimited axially by a rear face of an internal radial portion of piston 90 and by the front radial face of a closure part 94.

Control chamber 92 is selectively supplied with oil through orifice 28 that passes radially through hub 25 and is connected to one of supply channels 24 of control shaft 22.

Closure part 94 has, at its outer radial end, sealing means 96 that interact with an inner face of an axial portion of piston 90 and, at its inner radial end, sealing means 98 that interact with an outer surface 100 of hub 25.

Surface 100 associated with second clutch E2 is located axially rearward with respect to reaction means 60 arranged between said clutches E1 and E2, i.e. axially opposite surface 40 associated with piston 30 of first clutch E1.

Closure part 94 is preferably associated with an abutment part 102 that is axially immobilized by a stop ring 104 mounted in a groove 105 of hub 25.

Piston 90 has, at its inner radial end, sealing means 106 that interact with outer surface 100 of hub 25 when piston 90 is displaced axially between the disengaged and engaged positions by the pressurization of control chamber 92.

Like closure part 34 for first clutch E1, closure part 94 is configured, globally between its radial ends carrying sealing means 96 and 98, to come into axial interaction with the rear radial face of piston 90.

Control chamber 92 is associated with a compensating chamber 108 delimited by at least one compensating piston 110.

As compared with compensating piston 50 of first clutch E1 which is constituted by drive web 18, compensating piston 110 of second clutch E2 is a separate part.

Compensating chamber 108 is delimited axially by the rear radial face of compensating piston 110 and by the front radial face of piston 90.

Sealing of compensating chamber 108 is provided radially externally by sealing means 112 that are carried by piston 90 and that interact with the inner face of an axial portion of compensating piston 110.

The inner radial portion of piston 90 extends radially, and it is disposed axially between control chamber 92 located axially at the rear, and compensating chamber 108 located axially at the front.

Piston 90 of second clutch E2 has, at its external radial end, an actuating portion 115 constituted by a boss that extends axially to the front toward a multiple-disc assemblage of second clutch E2.

Actuating portion 115 of piston 90 of second clutch E2 is circumferentially continuous; as a variant, discontinuous.

Advantageously, the actuating portion constituted by fingers 54 of piston 30 of first clutch E1, and actuating portion 115 of piston 90 of second clutch E2 of said mechanism 20, are located radially on one radius centered on axis O of system 10.

Piston 30 of first clutch E1 and piston 90 of second clutch E2 each apply a clamping force to the multiple-disc assemblage associated with them along the axial direction but in opposite directions, since the reaction on faces 58 and 62 of reaction means 60 is opposite.

The multiple-disc assemblage of second clutch E2 has friction disks 114 that are rotationally connected to second driven shaft A2 by an external disc carrier 116 that constitutes the output element of clutch E2.

External disc carrier 116 has at the external radial periphery an axial portion that is equipped with an inner tooth set 117 intended to interact with an outer tooth set 118 that each of friction discs 114 comprises.

External disc carrier 116 has radial holes, distributed circumferentially in said axial portion equipped with tooth set 117, and intended for passage of the oil introduced into the multiple-disc assemblage of second clutch E2.

External disc carrier 116 is rotationally connected by meshing to friction discs 114, and by a splined connection to said second driven shaft A2.

External disc carrier 116 has an output hub 120 that extends axially and has, radially internally, splines 122 that mesh with complementary splines 123 of second driven shaft A2.

Said disc carrier 116 and output hub 120 are preferably fastened together by welding; as a variant, by riveting.

Friction discs 114 each have a friction lining 124 on their respectively front and rear axially opposite radial faces.

The multiple-disc assemblage of second clutch E2 has flanges 126 that are equipped at their inner radial periphery with a tooth set 128 in order to connect them rotationally to an internal disc carrier 130.

Internal disc carrier 130 has at its outer radial end an axial portion having an outer tooth set 132 that meshes with inner tooth set 128 of each of flanges 126 in order to rotationally connect them with zero clearance.

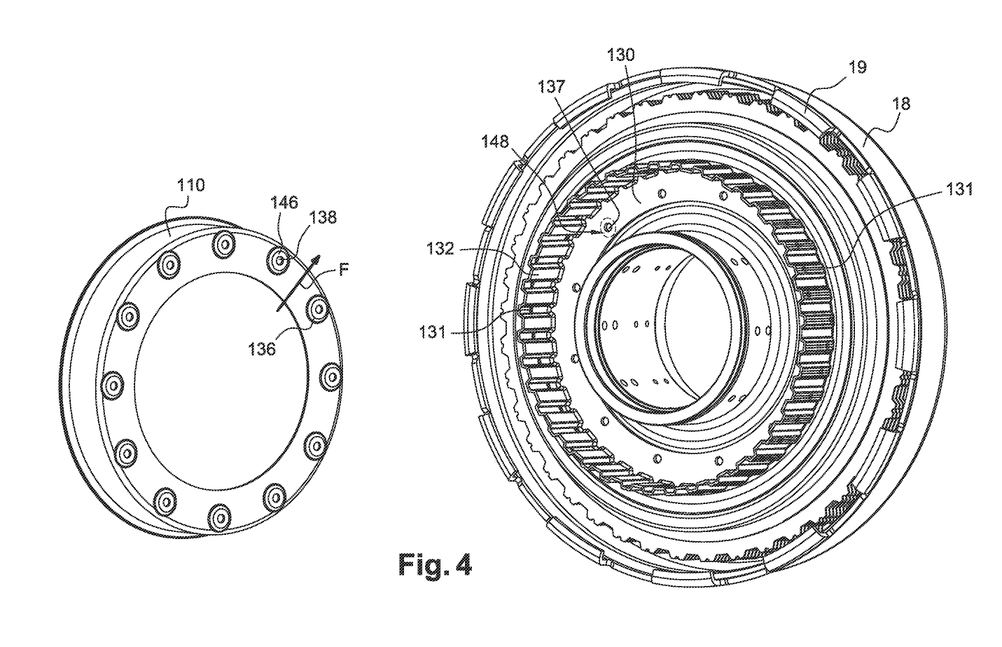

As illustrated in FIG. 4, internal disc carrier 130 has radial holes 131, distributed circumferentially in said axial portion equipped with tooth set 132, and intended for passage of the oil introduced into the multiple-disc assemblage of second clutch E2.

Friction discs 114 are, in individual fashion, axially interposed between two successive flanges 126.

Each of the friction linings 124 of one of friction discs 114 interacts, in an engaged position, with a radial face of one of the two flanges 126 arranged axially on either side.

The multiple-disc assemblage of second clutch E2 has, axially, a flange 126 at each of its ends, respectively a rear flange 126 whose rear radial face is intended to interact, in an engaged position, with actuating portion 115 of piston 90, and a front flange 126 whose front radial face is intended to interact with rear face 62 of reaction means 60.

Second clutch E2 has resilient return means 134 for automatically returning piston 90 into a disengaged position corresponding to an open state of the clutch.

Preferably, and as for first clutch E1, resilient return means 134 for piston 90 are constituted by resilient washers, such as spring washers of the “Onduflex™” type.

For direct transmission of input power, double wet clutch mechanism 20 has connecting means that, for second clutch E2, connect at least compensating piston 110, internal disc carrier 130 of second clutch E2, and said reaction means 60 with zero axial clearance.

Advantageously, the connecting means of second clutch E2 are implemented by riveting.

In this first embodiment, said connecting means of second clutch E2 are preferably constituted by rivets 85 that are shared with first clutch E1, so that said connecting means are constituted only by rivets 85.

As depicted in FIG. 1, the connecting means of double wet clutch mechanism 20 are arranged axially between piston 30 of first clutch E1 and piston 90 of second clutch E2.

The connecting means connect, with zero axial clearance, at least said drive web 18, internal disc carrier 80 of first clutch E1, internal disc carrier 130 of second clutch E2, and said reaction means 60.

Rivets 85 that constitute the connecting means allow drive web 18 to be connected simultaneously both to first clutch E1 and to second clutch E2 of the mechanism, and allow direct transmission of the input power delivered to system 10 by the driving shaft.

The connecting means are preferably used to ensure fastening of compensating piston 50 of first clutch E1, constituted here by web 18, and of compensating piston 110 of second clutch E2.

Advantageously, said connecting means 85 also connect compensating piston 50 of first clutch E1 and compensating piston 110 of second clutch E2 of mechanism 20 with zero axial clearance.

Reaction means 60 are interposed axially between internal disc carrier 80 of first clutch E1 and internal disc carrier 130 of second clutch E2 for direct transmission of input power to mechanism 20.

Like drive web 18 that constitutes compensating piston 50 of first clutch E1, compensating piston 110 of second clutch E2 has indentations 136 that each surround a hole 138 for the passage of one of rivets 85 that constitute the connecting means.

The front head of each rivet 85 abuts axially against the front radial face of compensating piston 50, here drive web 18, or more precisely is received at the front in the receptacle constituted by recess 86 around hole 88.

The front head of rivet 85 is advantageously encompassed axially in the thickness of drive web 18 that constitutes compensating piston 50 of first clutch E1.

As depicted in FIG. 3, said drive web 18 that constitutes compensating piston 50 of first clutch E1 has a series of holes 88 for passage of the body of rivets 85.

Internal disc carrier 80 of first clutch E1 has, in its inner radial portion, a series of axial holes 87 for the passage of rivets 85.

Reaction means 60 have a series of axial holes 140 (FIG. 1) for the passage of rivets 85.

As depicted in FIG. 4, disc carrier 130 of second clutch E2 has a series of holes 137 for the axial passage of rivets 85, and compensating piston 110 has a series of holes 138.

As depicted in section in FIG. 1, rivets 85 that constitute the connecting means according to the first embodiment axially interconnect, with zero clearance, drive web 18, internal disc carrier 80 of first clutch E1, reaction means 60 (here common to first and second clutches E1 and E2), internal disc carrier 130 of second clutch E2, and compensating piston 110 of second clutch E2.

When compensating piston 50, as a variant, is a separate part from drive web 18, compensating piston 50 is then also advantageously connected with zero axial clearance by rivets 85 in order to be kept in position.

Like the front head, the rear head of each rivet 85 abuts axially against the rear radial face of compensating piston 110; more precisely, it is received in the rear receptacle constituted by recess 136 around hole 138.

The rear head of rivet 85 is encompassed axially in the thickness of compensating piston 110 of second clutch E2.

The body of each rivet 85 passes axially, successively from rear to front, through hole 138 of compensating piston 110, hole 137 of internal disc carrier 130 of E2, hole 140 of reaction means 60, hole 87 of internal disc carrier 80 of E1, hole 88 of web 18 that constitutes compensating piston 50 of first clutch E1.

The connecting means constituted by rivets 85 nevertheless do not impede oil circulation radially from inside to outside, intended in particular to lubricate friction linings 74 and 124 of clutches E1 and E2.

As illustrated in FIGS. 3 and 4, indentations 86 of web 18 that constitutes compensating piston 50, like indentations 136 of compensating piston 110, are circumferentially discontinuous.

The number of indentations 86 and 136 corresponds to the number of rivets 85 used to implement the axial zero-clearance connection; here, for example, the number is twelve.

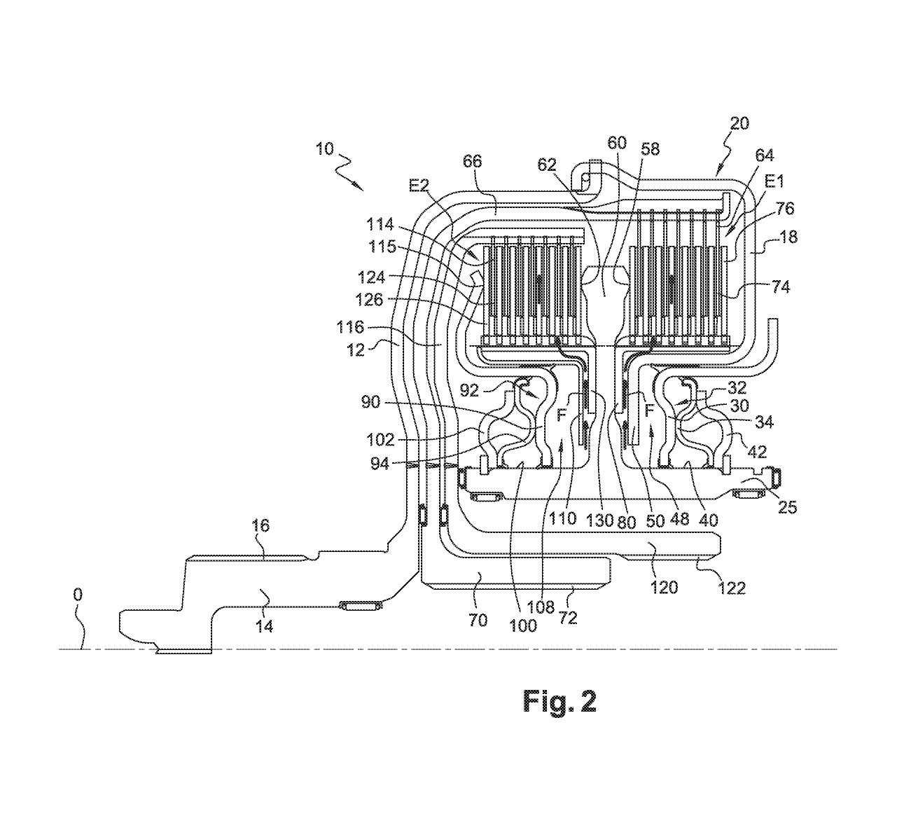

As depicted in FIG. 2, thanks to indentations 86 an axial clearance exists between the rear radial face of compensating piston 50 constituted by web 18 and the front radial face of internal disc carrier 80, allowing radial circulation of oil to the multiple-disc assemblage of first clutch E1.

Advantageously, oil passages are thus configured to allow oil circulation radially outward at the level of the connecting means constituted by rivets 85.

The oil circulates, radially from inside to outside according to the arrows depicted in particular in FIG. 2, utilizing radial oil passages F delimited circumferentially by two consecutive indentations 86 of web 18 that constitutes compensating piston 50 of first clutch E1, or by two circumferentially consecutive indentations 136 of compensating piston 110 of second clutch E2.

Some of the radial passages F utilized by the oil between indentations 86, 136 in each of clutches E1 and E2 of mechanism 20 have been depicted in FIGS. 3 and 4 with the aid of arrows.

For first clutch E1, the oil flow then passes radially through holes 81 of internal disc carrier 80 and circulates between friction discs 74 and flanges 76 of the multiple-disc assemblage of E1 before passing through the radial holes of external disc carrier 66.

For second clutch E2, the oil flow passes radially through holes 131 of internal disc carrier 130 and circulates between friction disks 114 and flanges 126 of the multiple-disc assemblage of E2 before passing through the radial holes of external disc carrier 116.

When the connecting means are implemented by riveting, sealing of compensating chamber 48 of first clutch E1 is provided, around holes 88, by contact between a radially planar annular face 142 that is constituted as a result of recess 86 and surrounds hole 88.

Once riveting has been performed in order to axially connect the parts together, said annular face 142 interacts with a segment 144 of the planar radial face surrounding hole 87 of internal disc carrier 80.

Said annular segment 144 of the radial face of internal disc carrier 80, with which one of said faces 142 around one of holes 88 of compensating piston 50 constituted by web 18 is in contact, is depicted in FIG. 3 with a dashed line around one of holes 87.

Sealing of compensating chamber 108 of second clutch E2 is provided, around holes 138, by contact between a radially planar annular face 146 that is constituted as a result of recess 136 and surrounds hole 138.

Once riveting has been performed in order to axially connect the parts together, said annular face 146 interacts with a segment 148 of the planar radial face surrounding hole 137 of internal disc carrier 130.

Annular segment 148 of the radial face, with which one of said faces 146 surrounding one of holes 138 is in contact, is depicted in FIG. 4 with a dashed line around one of holes 138.

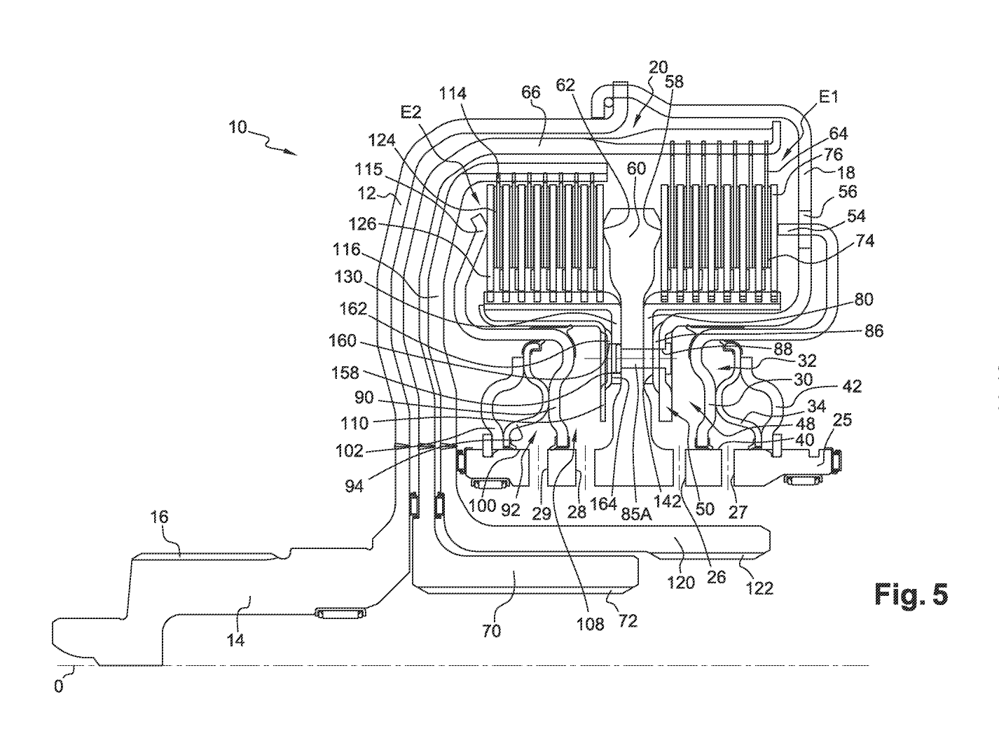

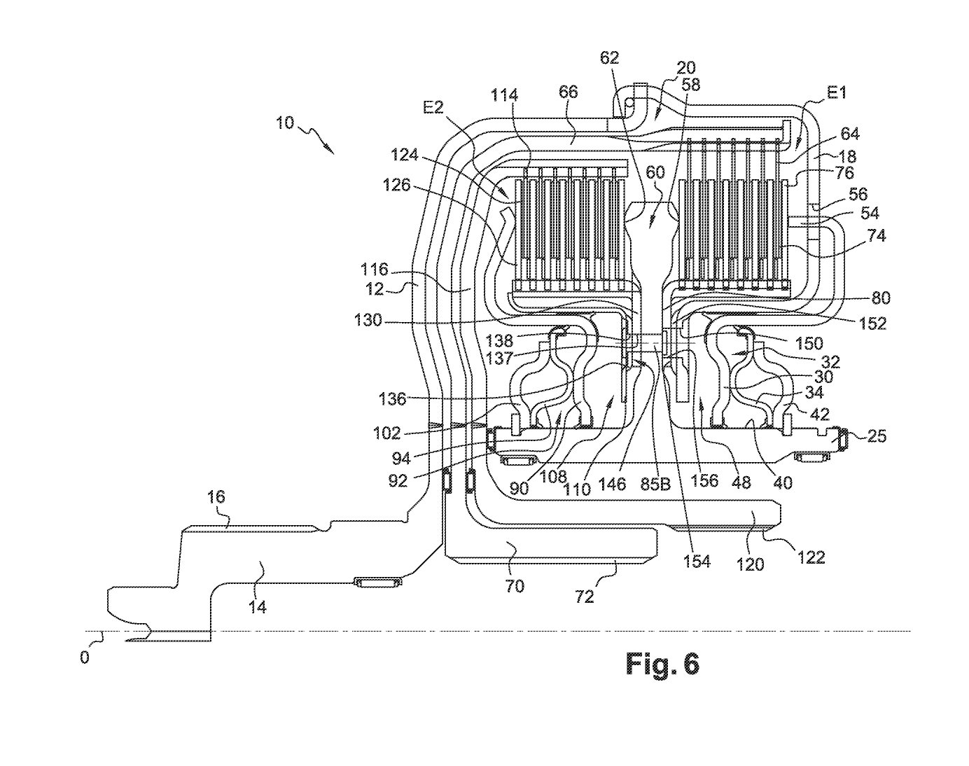

FIGS. 5 to 9 depict a second embodiment of the invention relating to a transmission system 10 having a double wet clutch mechanism 20.

The second embodiment will be described below by comparison with the first embodiment; identical reference numbers designate identical parts or parts having similar functions.

The description of transmission system 10 according to the first embodiment illustrated by FIGS. 1 to 4, and in particular that of double wet clutch mechanism 20, is consequently applicable to the second embodiment depicted in FIGS. 5 to 9.

In this second embodiment, the connecting means are implemented by riveting.

As a variant that is not depicted, said connecting means are implemented by welding, in particular transmission laser welding.

Advantageously, said connecting means have at least a series of first rivets 85A associated with first clutch E1 and a series of second rivets 85B associated with second clutch E2.

As compared with rivets 85 according to the first embodiment, each of rivets 85A and 85B axially connects a smaller number of parts, which allows the quality and thereby the reliability of the riveted connection to be improved. The rivet length is thus reduced, allowing improved expansion of the rivet in its receptacle during the riveting operation. The torque transmission capacity of the riveted connection is thus increased.

Preferably said first rivets 85A and second rivets 85B are respectively distributed circumferentially in alternating fashion around axis O.

First rivets 85A connect, with zero axial clearance, at least said drive web 18, internal disc carrier 80 of first clutch E1, and said reaction means 60.

As in the first embodiment, the inner radial portion of drive web 18 constitutes compensating piston 50 of first clutch E1.

As a variant that is not depicted, drive web 18 and compensating piston 50 are implemented in the form of two separate parts; first rivets 85A again connect compensating piston 50, with zero axial clearance, to the other parts 18, 80, and 60 in order to keep it in position.

Second rivets 85B connect, with zero axial clearance, at least compensating piston 110 of second clutch E2, internal disc carrier 130 of second clutch E2, and said reaction means 60.

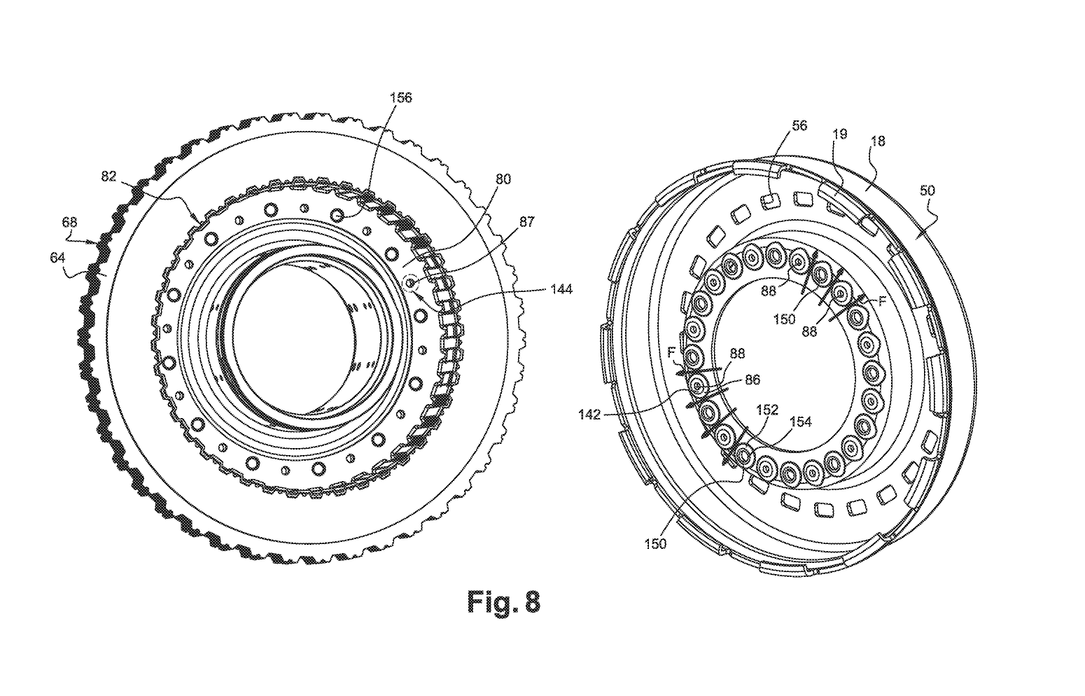

As depicted in FIG. 8, drive web 18 that constitutes compensating piston 50 of first clutch E1 has two series of holes, respectively holes 88 and holes 150 that are larger in diameter than holes 88.

Holes 88 are passed through by the bodies of first rivets 85A that constitute the connecting means associated with first clutch E1, and holes 150 are intended to allow passage, axially through drive web 18, for riveting second rivets 85B that constitute the connecting means associated with second clutch E2.

Like holes 88, each hole 150 is constituted at the center of a recess 152 and is surrounded by an annular face 154 to ensure sealing by interaction with a segment of the radial face of internal disc carrier 80 of clutch E1.

Internal disc carrier 80 of first clutch E1 likewise has holes 87 for passage of the bodies of rivets 85A, and holes 156, that are axially aligned with holes 150 of drive web 18, for the passage of second rivets 85B.

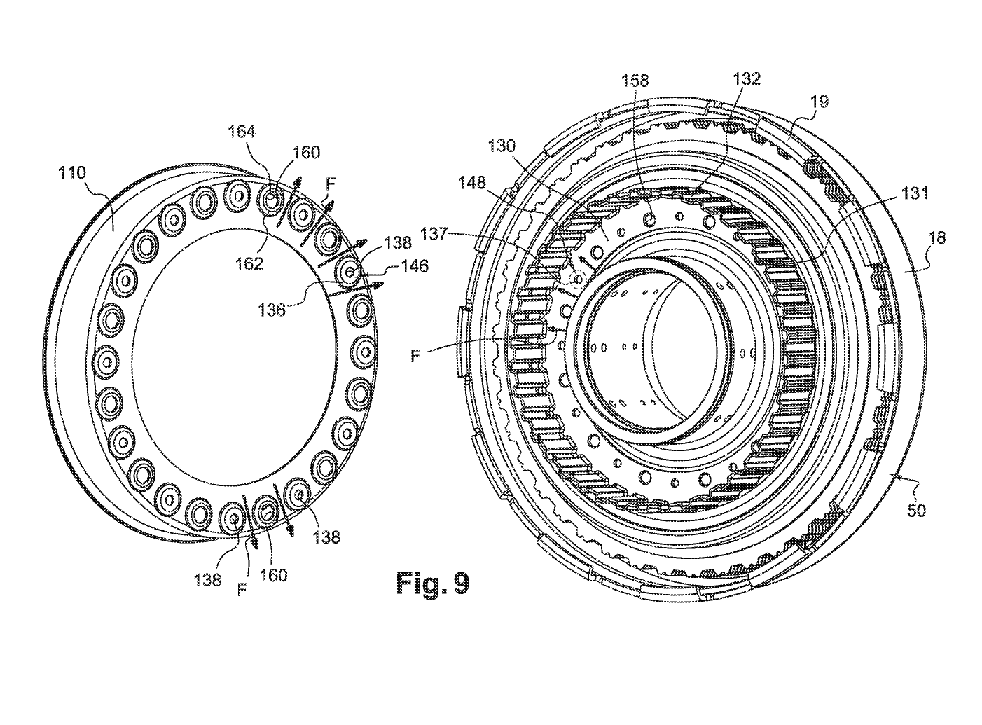

As depicted in FIG. 9, internal disc carrier 130 of second clutch E2 has holes 137 passed through by the bodies of rivets 85B, and holes 158 that are larger in diameter than holes 137.

Holes 158 are aligned with holes 160 of compensating piston 110 of second clutch E2 for the passage of first rivets 85A.

Compensating piston 110 of second clutch E2 has two series of holes, respectively holes 138 as in the first embodiment, and holes 160.

Holes 138 are passed through by the bodies of second rivets 85B that constitute the connecting means associated with second clutch E2, and holes 160 are intended to allow riveting of first rivets 85A.

Like holes 138, each hole 160 is constituted at the center of a recess 162 and is surrounded by an annular face 164 interacting with the opposite radial face of the axially adjacent internal disc carrier 130, in order to ensure sealing of compensating chamber 108 of second clutch E2.

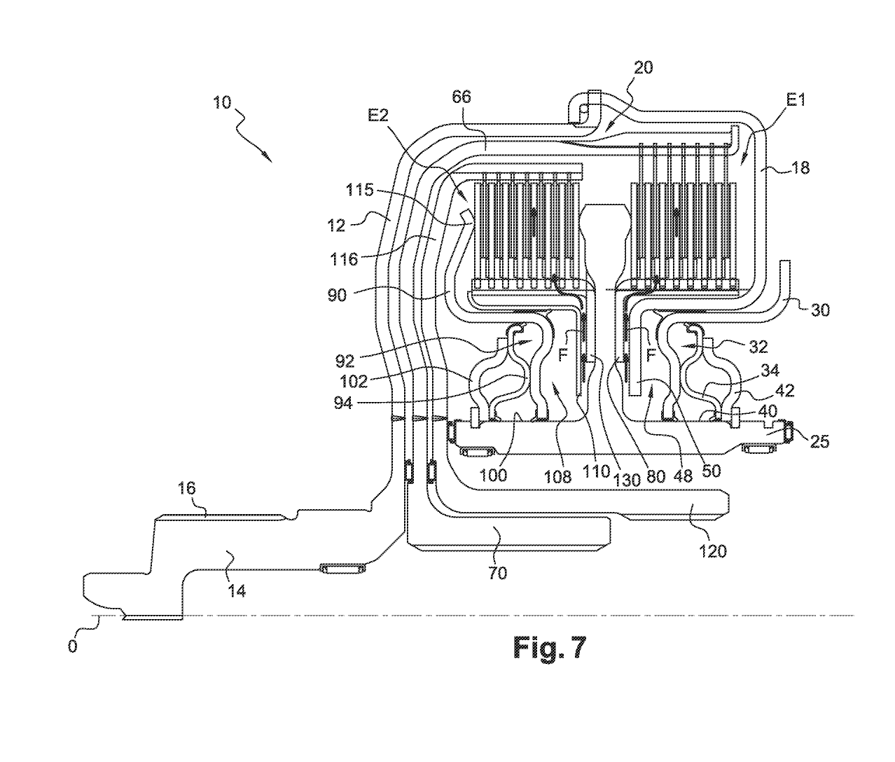

In this second embodiment, and as illustrated in FIG. 7, radial oil passages F are configured to allow circulation of oil radially outward at the level of the connecting means constituted by first rivets 85A and second rivets 85B.

Oil passage F occurs radially between indentations 86 and 152 for first clutch E1 and between indentations 136 and 162 for second clutch E2, said indentations being circumferentially discontinuous.

As in the first embodiment, radial oil passage F has been depicted schematically in FIGS. 8 to 9 with several arrows.

Oil circulation of course occurs radially over the entire circumference both of compensating piston 50 constituted by web 18 and of compensating piston 110 of second clutch E2, even though said arrows have not been depicted over the entire circumference.

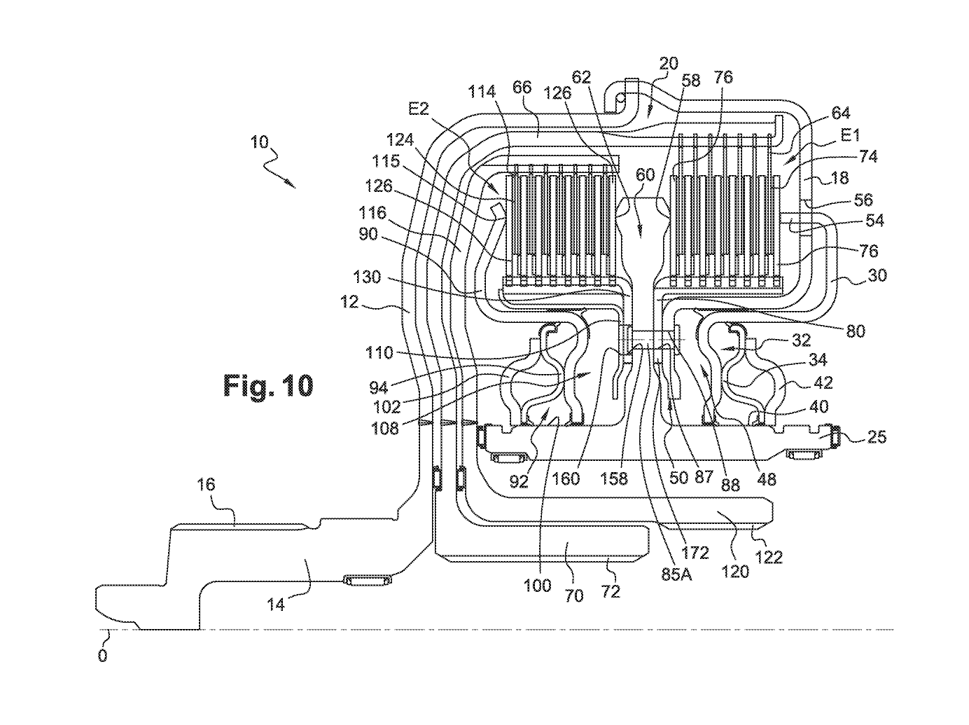

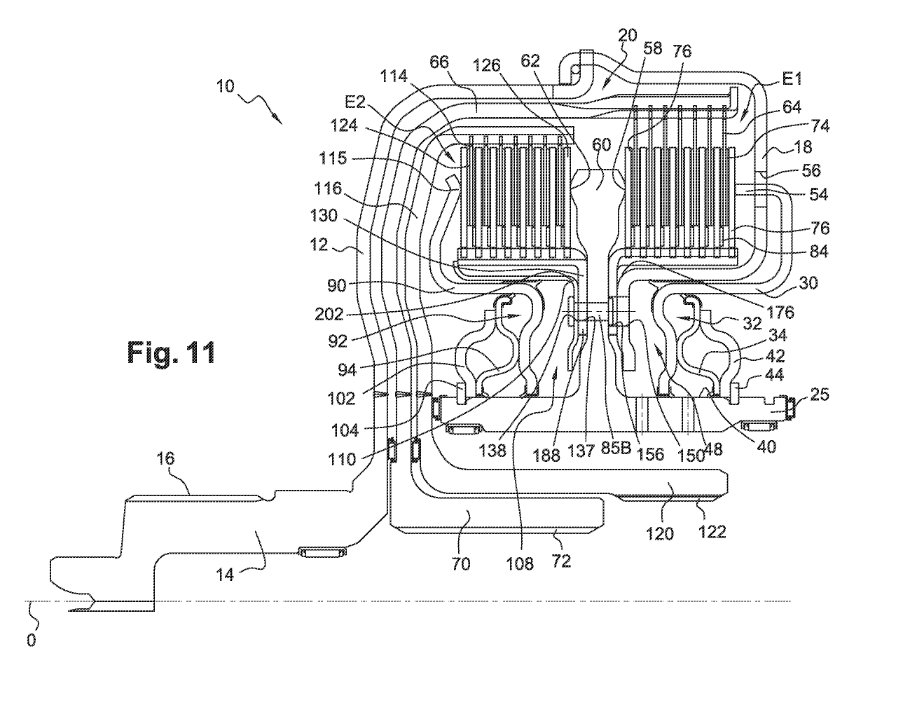

FIGS. 10 to 15 depict a third embodiment of the invention relating to a transmission system 10 having a double wet clutch mechanism 20.

The third embodiment will be described below by comparison with the second embodiment, identical reference numbers in the Figures designating identical parts or parts having similar functions.

The description of the connecting means of transmission system 10 provided above for the second embodiment depicted in FIGS. 5 to 9, as well as the general description of double wet clutch mechanism 20 provided for the first embodiment illustrated by FIGS. 1 to 4, are consequently applicable to the third embodiment.

This is because the connecting means according to this third embodiment are implemented by riveting by means of two series of rivets, respectively first rivets 85A and second rivets 85B, as in the second embodiment.

As a variant that is not depicted, the connecting means are constituted by a single series of rivets 85, as in the first embodiment.

Compensating piston 50 of first clutch E1 is preferably constituted by drive web 18, which (as before) performs a dual function: on the one hand transmission of input power, and on the other hand operation of compensating chamber 48 of first clutch E1.

In this third embodiment, compensating piston 50 constituted by web 18, and compensating piston 110 of second clutch E2, are devoid of indentations.

As compared with the second embodiment, indentations 86 in compensating piston 50 constituted by web 18, and indentations 136 in compensating piston 110 of second clutch E2, are deleted.

Advantageously, deletion of the indentations makes it possible in particular to reduce the axial space requirement of the assemblage of parts connected with zero axial clearance by first rivets 85A and second rivets 85B.

As described previously, mechanism 20 has oil passages F to allow radial circulation of oil from inside to outside at the level of the connecting means implemented by riveting.

Advantageously, in this third embodiment the radial circulation of oil occurs through passthrough windows configured for first clutch E1 between internal disc carrier 80 and web 18, and for second clutch E2 between internal disc carrier 130 and compensating piston 110.

First clutch E1 circumferentially comprises oil passthrough windows 166 obtained via cutouts 168 implemented in internal disc carrier 80.

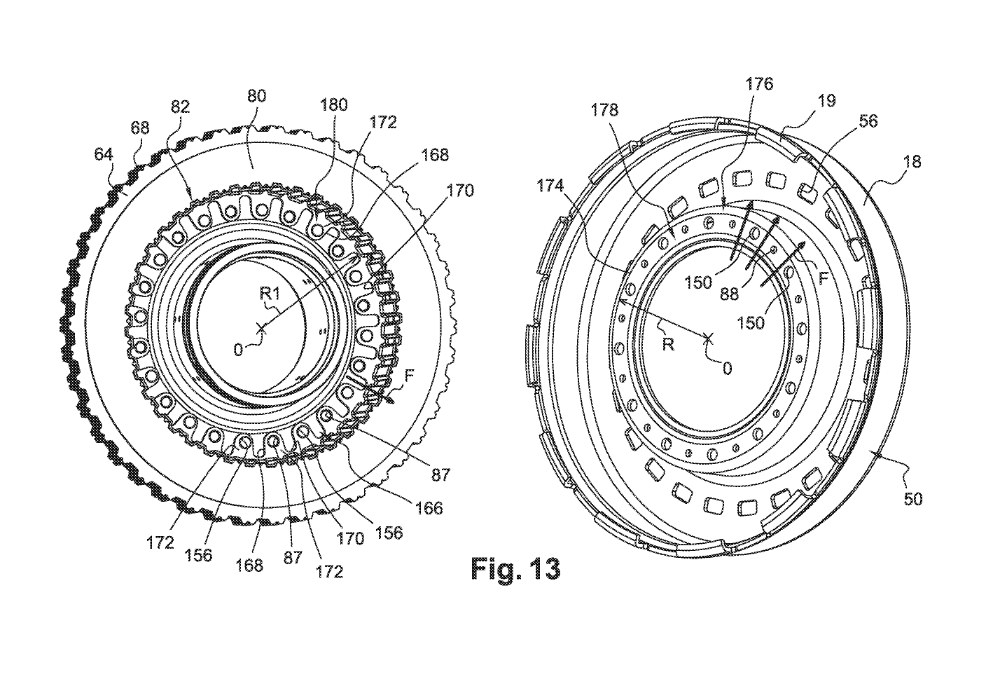

As depicted in FIG. 13, internal disc carrier 80 of first clutch E1 circumferentially comprises an alternation of cutouts 168 delimited radially externally by a rim 170, and fastening tabs 172 for axial connection of internal disc carrier 80 by riveting.

Fastening tabs 172 extend radially inward with respect to external rim 170 of cutouts 168.

Fastening tabs 172 alternatingly comprise holes 87 for passage of the bodies of rivets 85A and holes 156, larger in diameter than holes 87, for riveting of rivets 85B.

As a variant that is not depicted, the connecting means are constituted by rivets 85 as in the first embodiment, and fastening tabs 172 then have only holes 87 for the passage of rivets 85.

Cutouts 168 are implemented in such a way that external rim 170 is located on a radius R1 that is larger than radius R of upper rim 174 of drive web 18 that constitutes compensating piston 50 of first clutch E1.

Web 18 preferably has a bent segment 176 in the radially outward extension of rim 174.

Holes 88 and 150 of drive web 18 open into a rear radial face 178 which is circumferentially continuous and planar, and with which a front radial face 180 of fastening tabs 172 interacts when the axially zero-clearance connection by riveting is implemented.

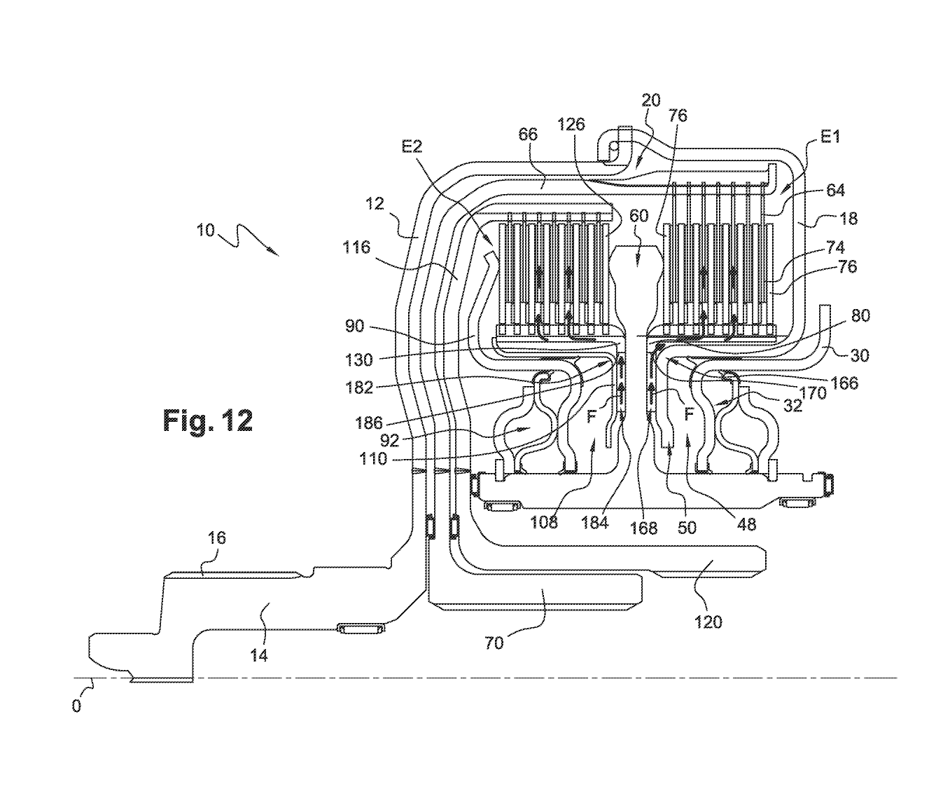

As depicted in FIG. 12, oil circulates between internal disc carrier 80 and web 18, passing radially through cutouts 168 between fastening tabs 172, and utilizes passthrough windows 166 delimited radially internally by rim 174 of the web and radially externally by rim 170.

The characteristics (shape, dimensions, passage cross section, etc.) of a passthrough window 166 are determined in particular by the difference between the radius R1 of rim 170 and the radius R of rim 174 of drive web 18; the greater the difference, the larger window 166 will be.

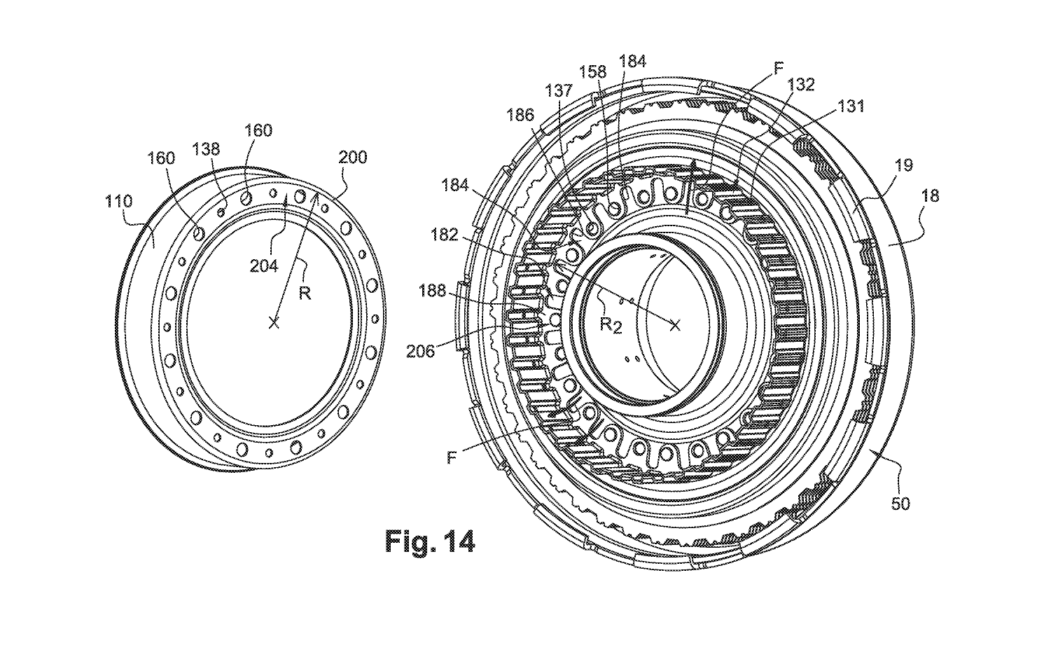

The shape of external rim 170 also plays a role in determining the characteristics of a passthrough window 166, said rim 170 illustrated in FIGS. 13 and 14 being curvilinear.

As a variant, external rim 170 of cutout 168 is globally rectilinear and circumferentially wider in order to form with fastening tabs 172, for example, a “crenelated” profile.

Second clutch E2 circumferentially comprises oil passthrough windows 182 between internal disc carrier 130 and compensating piston 110, said oil passthrough windows 182 being obtained by way of cutouts 184 implemented in internal disc carrier 130.

As depicted in FIG. 14, internal disc carrier 130 circumferentially comprises an alternation of cutouts 184 delimited radially externally by a rim 186.

Internal disc carrier 130 of second clutch E2 has fastening tabs 188 for axial zero-clearance connection of internal disc carrier 130 by riveting, in this third embodiment for connecting internal disc carrier 130 to reaction means 60 and compensating piston 110 via second rivets 85B.

Fastening tabs 188 extend radially inward with respect to external rim 186 that radially delimits each cutout 184.

The radially inner portion of internal disc carrier 130 is constituted by an alternation of cutouts 184 and fastening tabs 188, two consecutive tabs 188 being separated by a cutout 184.

Fastening tabs 188 alternatingly comprise holes 137 for passage of the body of rivets 85B and holes 158, larger in diameter than holes 137, for riveting of rivets 85A.

As a variant that is not depicted, the connecting means are constituted by rivets 85 as in the first embodiment, and fastening tabs 188 then have only holes 137 for passage of the body of rivets 85.

As described for first clutch E1, cutouts 184 configured in internal disc carrier 130 of second clutch E2 are implemented in such a way that external rim 186 is located on a radius R2 that is larger than the radius R′ of rim 200 of compensating piston 110.

Compensating piston 110 preferably has a bent segment 202 in the radially outward extension of rim 200.

Holes 138 and 160 of compensating piston 110 open into a front radial face 204 that is planar and circumferentially continuous.

Front radial face 204 interacts with a rear radial face 206 of fastening tabs 188 once the axial connection, by riveting, of compensating piston 110 and internal disc carrier 130 has been performed.

As depicted in FIG. 12, oil circulates between internal disc carrier 130 and compensating piston 110 by passing radially through cutouts 184; otherwise the oil would be blocked at the level of rivets 85B that axially clamp internal disc carrier 130 and compensating piston 110 together.

The oil utilizes passthrough windows 182, which are each delimited radially internally by rim 200 of compensating piston 110, and radially externally by rim 186 of cutout 184 in internal disc carrier 130.

The characteristics of a passthrough window 182 are determined in particular by the difference between the radius R2 of external rim 186 of the cutout and the radius R′ of rim 200 of compensating piston 110, and by the shape of the cutout and very particularly by that of its external rim 186.

Oil passes through the circumferentially distributed passthrough windows 182 between internal disc carrier 130 and compensation piston 110, flowing between external rim 186 and bent segment 202, then continues to travel radially outward toward the multiple-disc assemblage of second clutch E2, passing through the axial portion of internal disc carrier 130 via radial holes 131.

1. A transmission system (10), especially for a motor vehicle, having around an axis (O) at least
an input shell (12) that is rotationally connected to a driving shaft and to a drive web (18) in order to rotationally connect said input shell (12) to a double wet clutch mechanism (20) that is controlled to selectively couple said driving shaft to a first driven shaft (A1) and to a second driven shaft (A2),
said double wet clutch mechanism (20) having at least a first clutch (E1) and a second clutch (E2) respectively of the multiple-disc type, each of said first and second clutches (E1, E2) having at least one axially movable piston (30, 90) that is controlled as to displacement by means of a control chamber (32, 92) with which is associated a compensating chamber (48, 108) delimited at least by a compensating piston (50, 110), said piston (30, 90) causing axial clamping, in an engaged position, of a multiple-disc assemblage against reaction means (60), said multiple-disc assemblage having at least friction discs (64, 114) rotationally connected to an external disc carrier (66, 116) and flanges (76, 126) that are rotationally connected via at least one internal disc carrier (80, 130) to one of said first and second driven shafts (A1, A2),
wherein the drive web (18), the internal disc carrier (80) of the first clutch (E1), the internal disc carrier (130) of the second clutch (E2), and said reaction means (60) interposed axially between said internal disc carriers (80, 130) are separate parts; and
said double wet clutch mechanism (20) has connecting means (85) arranged axially between the pistons (30, 90) of the first clutch (E1) and of the second clutch (E2) which, for direct transmission of input power, connect at least the separate parts together with zero axial clearance.

2. The system according to claim 1, wherein said connecting means (85) also connect, with zero axial clearance, the compensating piston (50) of the first clutch and the compensating piston (110) of the second clutch (E2).

3. The system according to claim 1, wherein said connecting means (85) are implemented by riveting.

4. The system according to claim 3, wherein said connecting means (85) have at least a series of first rivets (85A) associated with the first clutch (E1) and a series of second rivets (85B) associated with the second clutch (E2).

5. The system according to claim 4, wherein said first rivets (85A) connect, with zero axial clearance, at least said drive web (18), the internal disc carrier (80) of the first clutch (E1), and said reaction means (60).

6. The system according to claim 4, wherein said second rivets (85B) connect, with zero axial clearance, at least the internal disc carrier (130) of the second clutch (E2) and said reaction means (60).

7. The system according to claim 1, wherein oil passages (F) are configured to allow oil circulation radially outward at the level of the connecting means (85).

8. The system according to claim 7, wherein the compensating piston (50) of the first clutch (E1) and the compensating piston (110) of the second clutch (E2) have indentations (86, 136) that delimit, between two circumferentially consecutive indentations, said radial oil passages (F).

9. The system according to claim 7, wherein said radial oil passages (F) are constituted by windows (166, 182) obtained by cutting out the internal disc carrier (80, 130) between circumferentially consecutive fastening tabs (172, 188).

10. The system according to claim 1, wherein the drive web (18) has openings (56) for axial passage of an actuating portion (54) of the piston (30) of the first clutch (E1).

11. The system according to claim 1, wherein the drive web (18) constitutes the compensating piston (50) of the first clutch (E1).

12. The system according to claim 1, wherein the first clutch (E1) and the second clutch (E2) of said double wet clutch mechanism (20) are axially juxtaposed, the first clutch (E1) and the second clutch (E2) being arranged axially on either side of said reaction means (60).

13. The system according to claim 1, wherein the piston (30) of the first clutch (E1) and the piston (90) of the second clutch (E2) of said mechanism (20) travel axially in opposite directions in order to cause clamping of said associated friction discs (64, 114) in an engaged position.

14. The system according to claim 1, wherein said connecting means are implemented by welding.

15. The system according to claim 1, wherein said connecting means are installed radially between the axis O and the multiple-disc assemblage.

16. The system according to claim 2, wherein said connecting means (85) are implemented by riveting.

17. The system according to claim 2, wherein oil passages (F) are configured to allow oil circulation radially outward at the level of the connecting means (85).

18. The system according to claim 3, wherein oil passages (F) are configured to allow oil circulation radially outward at the level of the connecting means (85).
